(19) United States
(12) Patent Application Publication
(10) Pub. No.: US 2009/0273386 A1
(43) Pub. Date: Nov. 5, 2009

(54) APPARATUS FOR CURRENT-TO-VOLTAGE INTEGRATION FOR CURRENT-TO-DIGITAL CONVERTER

(75) Inventors: Oleg Korobeynikov, Swampscott, MA (US); Joseph M. Kulinets, North Andover, MA (US); Vladimir Protasov, Revere, MA (US); Peter R. Nuytkens, Melrose, MA (US)

Correspondence Address: GOODWIN PROCTER LLP;PATENT ADMINISTRATOR, 53 STATE STREET, EXCHANGE PLACE, BOSTON, MA, 02109-2881, US

(73) Assignee: Custom One Design, Inc, Melrose, MA (US)

(21) Appl. No.: 12/113,728

(22) Filed: May 1, 2008

(51) Int. Cl. G06G 7/186

(52) U.S. Cl. 327/337

(57) ABSTRACT

Methods and apparatus for improved current-to-voltage integrators reducing charge injection and kT/C errors from capacitor switching and intrinsic operational amplifier noise (i.e., offset, 1/f noise, thermal noise) during the reset cycle of the integrator, simultaneously reducing demands on the reference voltage source, using correlated double sampling to compensate for DC offset and low frequency op-amp noises, and “fake” integration and a capacitor divider to eliminate or significantly reduce kT/C noise and charge injection.

### CROSS-REFERENCE TO RELATED APPLICATIONS

This application is related to and claims the benefit of the United States Patent Application bearing Docket No. COD-006, entitled “Methods and Apparatus for Reducing Non-Ideal Effects in Operational Amplifiers” and filed contemporaneously herewith, which is hereby incorporated by reference as if set forth in its entirety herein.

### FIELD OF THE INVENTION

The present invention relates to methods and apparatus for current-to-voltage conversion, and in particular to current-to-voltage integrators suitable for use as an input stage to current-to-digital converters, e.g., for applications in computed tomography (CT), luggage scanners, and similar devices.

### BACKGROUND OF THE INVENTION

CT is one technique for acquiring a three-dimensional image of a subject, i.e., a human body or anything capable of being imaged, from a sequence of two-dimensional images. In one exemplary CT imaging system, an X-ray source emits a fan-shaped beam or cone-shaped beam toward a subject. The beam, after being attenuated by the subject, impinges upon an array of radiation detectors. The intensity of the attenuated beam of radiation received at the detector array is typically dependent upon the attenuation of the X-ray beam by the subject. Each detector element of the detector array produces a separate electrical signal indicative of the attenuated beam impinging on that detector element. The electrical signals are transmitted to a data processing system for analysis which ultimately produces an image. There are many known implementations and configurations for CT imaging, but this discussion is focused on this exemplary system.

In this exemplary system, the subject is placed on a gantry prior to imaging. Generally, the X-ray source and the detector array are rotated about the gantry within an imaging plane and around the subject. X-ray sources typically include X-ray tubes, which emit an X-ray beam at a focal point. X-ray detectors typically include a collimator for collimating X-ray beams received at the detector, a scintillator adjacent the collimator for converting X-rays to light energy, and photodiodes for receiving the light energy from the adjacent scintillator and producing electrical signals therefrom.

Typically, each scintillator of a scintillator array converts X-rays to light energy. Each scintillator discharges light energy to an adjacent photodiode. Each photodiode detects the light energy and generates a corresponding electrical signal. The outputs of the photodiodes are then transmitted to the data processing system for image reconstruction.

To perform this task the photodiodes are typically operating in a photovoltaic mode generating electrical current, transforming the flux of light into electrical charge. The current from each photodiode is first integrated by an input integrator that transforms the input current, or electrical charge, into a voltage value on the output of the integrator. At the end of the integration cycle the voltage at the output of the input integrator is supplied to a voltage-to-digital converter, which converts analog voltage values into digital values.

### Sources of Error

Modem CT systems require a very large dynamic range (up to 1:1,000,000) and accuracy, so it is desirable to have very precise data acquisition systems providing data to them. These characteristics impose strict requirements on the accuracy and resolution of the charge-to-digital converters used. Any errors introduced into the process of charge/current integration are directly reflected in the results of the conversion and imaging.

Before the beginning of each integration cycle, the integrating capacitor of the input integrator should be brought into an initial state, destroying the charge accumulated in the previous conversion cycle. Therefore in integrating amplifiers (e.g., in various analog integrators and switched capacitor integrators), integrating capacitors are “reset,” i.e., discharged to zero volts or charged to a particular voltage (most often, reference voltage), prior to each integrating cycle.

FIG. 1 illustrates a current-to-voltage integrator known to the prior art. The circuit in FIG. 1 depicts a reset by discharging to zero volts, here by closing a switch 35 to short-circuit the two terminals of an integrating capacitor 36. One consequence of resetting integrating capacitors to zero volts is that upon opening the switch that short-circuits the integrating capacitor, the thermal noise (i.e., kT/C noise) is sampled on the integrating capacitor This is because the reset operation is essentially the sample and hold operation, in which the zero voltage signal (or reference voltage in some implementations) is sampled by the integrating capacitor.

Thermal noise arises from the random motion of free electrons in a conducting medium. Each free electron inside the medium is in motion due to its thermal energy. Since capacitors are noiseless devices, the capacitors of sampling circuits do not have any thermal noise associated with them. However, thermal noise will be present in the switch used for the sampling operation or an amplifier used in the sampling operation. The sampled thermal noise introduces undesired voltage errors into the sampled reset voltage. In the case of an integrator, the thermal noise sampled during the reset cycle can also appear as error charge injection.

The integrated thermal noise power of a sampling circuit is the product of the thermal noise spectral density and the thermal noise bandwidth of the circuit. In the case where a switch is used in connection with a sample and hold operation, the thermal noise spectral density and the thermal noise bandwidth are calculated in part based on the on-resistance of the switch. In the case where an amplifier is used in connection with the sample and hold operation, the thermal noise spectral density and the thermal noise bandwidth are calculated in part based on the transconductance of the amplifier. In conventional sampling circuits, the spectral density and the bandwidth of the thermal noise are dominated by the same element, for example, the switch or the amplifier of the sampling circuit.

When the integrated thermal noise power is calculated, the result is kT/C, where k is Boltzmann's constant, T is the ambient temperature, and C is the capacitance of the sampling capacitor, because the on-resistance of the switch or the transconductance of the amplifier cancels in the spectral density and bandwidth terms. Although the capacitance of the sampling capacitor selected can be increased to reduce the sampled thermal noise, a large integrating capacitance is undesirable where the integrator is a current-to-voltage converter stage in a charge-to-digital converter, because a larger capacitor reduces the gain of the current-to-voltage stage and reduces the dynamic range of the whole data acquisition system.

In the reset circuitry for the integrators, the required switches are typically implemented using a simple MOS transistor as a switch. When the transistor is open, current flows freely through it and when the transistor is closed the current is turned off. The current is equal to the amount of charge per unit of time passing through the channel. When the MOS-switch turns off, the charges in the channel are pushed out of the channel to the drain and the source sides. This results in a charge injection error if, for example, the sampling capacitor is located next to the switch.

Accordingly, there is a need for a current-to-voltage converter architecture that resets integrating capacitors to zero volts during the reset cycle preceding each integration cycle and employs advanced methods for the reduction of kT/C noise, charge injection errors, 1/f noise errors, and other errors that could be introduced during the reset cycle. Therefore, there is a need to develop new methods and architectures for integrators used as an input current-to-voltage converting stage of complex CT systems.

### SUMMARY OF THE INVENTION

Embodiments of the present invention relate to improvements in current-to-voltage integrators that reduce charge injection and kT/C errors from capacitor switching and intrinsic operational amplifier noise (i.e., offset, 1/f noise, thermal noise) during the reset cycle of the integrator, simultaneously reducing demands on the reference voltage source. Such current-to-voltage integrators are useful as a front-end integrator to an analog-to-digital converter suitable for converting the photovoltaic current from a photodiode array to digital data in X-ray-to-digital data acquisition systems of CT systems.

Certain embodiments of the present invention use correlated double sampling to compensate for DC offset and low frequency noises of an operational amplifier, and “fake” integration and a capacitor divider to eliminate or significantly reduce kT/C noise and charge injection, which emerge during internal switch openings and are sampled by different internal capacitors. Such elimination or significant reduction takes place at all switch openings and sampling of kT/C noise by a capacitor.

In one aspect, embodiments of the present invention provide a current-to-voltage integrator comprising an operational amplifier, first switching circuitry, a first integrating capacitor, second switching circuitry, a second integrating capacitor, third switching circuitry, and fourth switching circuitry. The operational amplifier has an inverting input receiving an input signal, an output, and a non-inverting input coupled to a reference voltage. The first switching circuitry has a first terminal coupled to the output and a second terminal. The first integrating capacitor has a first terminal coupled to the inverting input and a second terminal coupled to the second terminal of the first switch. The second switching circuitry has a first terminal coupled to the output and a second terminal. The second integrating capacitor has a first terminal coupled to the inverting input and a second terminal coupled to the second terminal of the second switch. The third switching circuitry has a first terminal coupled to the inverting input and a second terminal coupled to the output. The fourth switching circuitry has a first terminal coupled to the second terminal of the first integrating capacitor and a second terminal coupled to the reference voltage. The switching circuitries are configured for operation so as to integrate the input signal on the first integrating capacitor and to integrate kT/C noise on the second integrating capacitor.

In one embodiment, the first integrating capacitor is a programmable capacitor array. In another embodiment, the third switching circuitry is a T-switch having a third terminal connected to the reference voltage. In still another embodiment, the input signal is the current generated by a photodiode having an anode coupled to the inverting input and a cathode coupled to the reference voltage. In yet another embodiment, the integrator includes a noise-suppressing capacitor having a first terminal coupled to the second terminal of the second integrating capacitor and a second terminal coupled to a reference voltage. The noise-suppressing capacitor may be larger than the second integrating capacitor.

In another embodiment, a signal generator is coupled to at least one of the switching circuitry and generating signals controlling the operation of said at least one switching circuitry. In still another embodiment, a load capacitor is coupled to the second terminal of the first integrating capacitor. In yet another embodiment, the output of the operational amplifier is coupled to an analog-to-digital converter.

In still another aspect, embodiments of the present invention provide a current-to-voltage integrator having an operational amplifier, first switching circuitry, a first integrating capacitor, second switching circuitry, a second integrating capacitor, third switching circuitry, fourth switching circuitry, and a noise-suppressing capacitor. The operational amplifier has an inverting input receiving an input signal, an output, and a non-inverting input coupled to a reference voltage. The first circuitry has a first terminal coupled to the output and a second terminal. The first integrating capacitor has a first terminal coupled to the inverting input and a second terminal coupled to the second terminal of the first switch. The second switching circuitry has a first terminal coupled to the output and a second terminal. The second integrating capacitor has a first terminal coupled to the inverting input and a second terminal coupled to the second terminal of the second switch. The third switching circuitry has a first terminal coupled to the inverting input and a second terminal coupled to the output. The fourth switching circuitry has a first terminal coupled to the second terminal of the first integrating capacitor and a second terminal coupled to the reference voltage. The noise-suppressing capacitor has a first terminal coupled to the second terminal of the second integrating capacitor and a second terminal coupled to the reference voltage and is larger than the second integrating capacitor.

In one embodiment, the first integrating capacitor is a programmable capacitor array. In another embodiment, the third switching circuitry is a T-switch having a third terminal connected to the reference voltage. In still another embodiment, the input signal is the current generated by a photodiode having an anode coupled to the inverting input and a cathode coupled to the reference voltage. In yet another embodiment, a signal generator is coupled to at least one of the switching circuitry and generates signals controlling the operation of said at least one of the switching circuitry. In still another embodiment, a load capacitor is coupled to the second terminal of the first integrating capacitor. In another embodiment, the output of the operational amplifier is coupled to an analog-to-digital converter.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 is a block diagram of a prior art current-to-voltage integrator;

FIG. 2 presents a block diagram of one embodiment of a current-to-voltage integrator in accord with the present invention, with all switches shown in their positions at the beginning of the reset cycle (i.e., Phase A of the reset cycle presented in FIG. 3);

FIG. 3 presents a timing diagram depicting the sequence of control signals applied to the integrator of FIG. 2 during its reset, integration, and conversion cycles;

FIG. 4A presents a block diagram of an embodiment of a current-to-voltage integrator in accord with the present invention, the integrator operating in Phase A of the reset cycle of FIG. 3;

FIG. 4B presents a equivalent diagram of the integrator of FIG. 4A;

FIG. 5A presents a block diagram of the integrator of FIG. 4A operating in Phase B of the reset cycle of FIG. 3;

FIG. 5B presents a equivalent diagram of the integrator of FIG. 5A;

FIG. 6A presents a block diagram of the integrator of FIG. 4A operating in Phase C of the reset cycle of FIG. 3;

FIG. 6B presents a equivalent diagram of the integrator of FIG. 6A;

FIG. 7A presents a block diagram of the integrator of FIG. 4A operating in Phase D of the reset cycle of FIG. 3;

FIG. 7B presents a equivalent diagram of the integrator of FIG. 7A;

FIG. 8A presents a block diagram of the integrator of FIG. 4A operating in Phase E of the reset cycle of FIG. 3; and

FIG. 8B presents a equivalent diagram of the integrator of FIG. 8A.

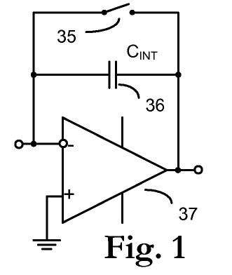

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

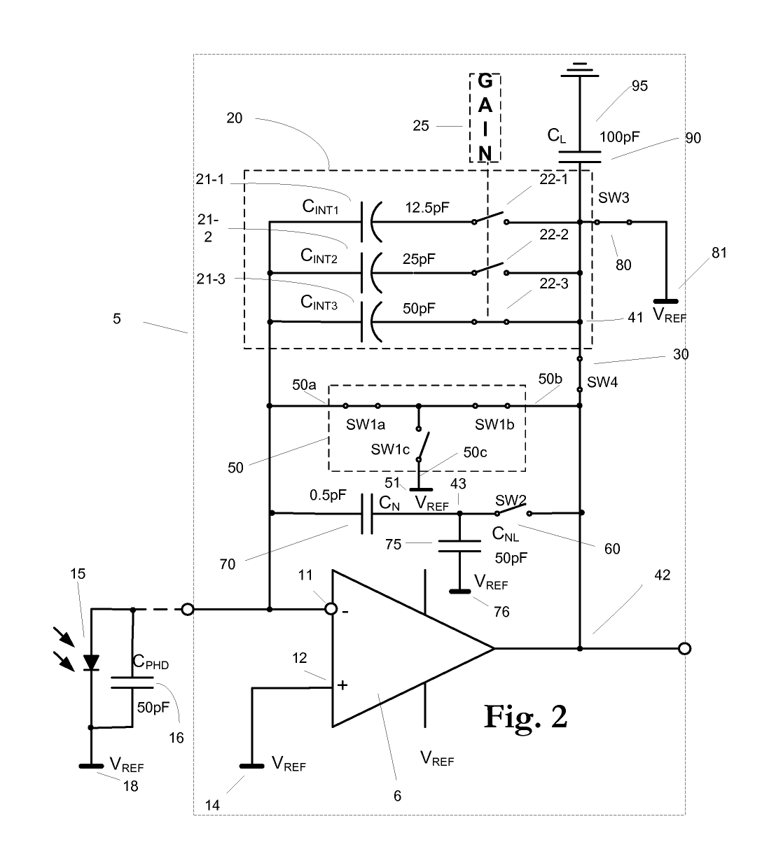

FIG. 2 depicts one embodiment of a current-to-voltage integrator 5 in accord with the present invention. FIG. 2 also shows the connection of an ideal photodiode 15 as it is supposed to be connected to the integrator 5, together with the parasitic capacitance 16 associated with this connection. The connection of an actual photodiode 15′ may differ significantly from the connection of the ideal photodiode 15 and may include additional switches, etc.

Still referring to FIG. 2, current-to-voltage integrator 5 includes an operational amplifier 6 having an inverting (−) input connected to node 11, and a non-inverting (+) input connected by node 12 to reference voltage V_{REF} at node 14 that replaces the “virtual ground” normally used in such integrator circuits. Other embodiments may utilize another suitable bias voltage node 14′, in which case the “virtual reference voltage” referred to hereinafter would be equal to that bias voltage.

Inverting input node 11 is indirectly coupled to the anode of an external photodiode 15 having parasitic capacitance C_{PHD} 16. The parasitic capacitance C_{PHD} 16 includes the capacitance of switches, conductors, wires and cables (not shown) coupling the external photodiode 15 to input node 11 and the intrinsic capacitance of the photodiode 15. As discussed below, parasitic capacitance C_{PHD} 16 will be used as a second sampling capacitor in correlated double sampling operation of embodiments of the proposed invention. In practice, the value of parasitic capacitance C_{PHD} 16 is typically in the range from 10 to 100 pF. The cathode of the external photodiode 15 is connected to the node 18 that is at the same reference voltage potential V_{REF}, referred to here as the “virtual reference voltage,” as node 14.

Node 11 is further connected to a first terminal of a programmable capacitor array 20 which functions as an integrating capacitor having a capacitance C_{INT} equal to the sum of all of the component capacitors in the array, i.e. C_{INT}=ΣC_{INTi} Capacitor array 20 includes a plurality of binarily weighted capacitors 21-1, 21-2, 21-3, etc. that are connected in parallel through the capacitance control switches 22-1, 22-2, 22-3, etc., which allow adjustment of the gain of the current-to-voltage integrator 5 by adjusting the value of C_{INT}. Different bits of the digital gain value are served as control signals to switch ON or OFF the capacitance control switches 22-1, 22-2, 22-3, etc. A digital code provided through gain select input 25 selects the absolute value of C_{INT} and hence the gain of current-to-voltage integrator 5. There can be any number of binarily weighted capacitors and respective capacitance control switches in a programmable capacitor array 20 or control bits in the gain value.

The values of the constituent capacitors C_{INTi} are shown in FIG. 2 for illustrative purposes only, and are in no way a restriction on the scope of current invention. In practice, the range of C_{INT} can be typically from 10 to 500 pF. Capacitor array 20, hereinafter also referred to as “integrating capacitor C_{INT}” 20, is coupled between the inverting input 11 and the output 42 of operational amplifier 6 by switch SW4 30 which is coupled between nodes 41 and 42.

The output of operational amplifier 6 is connected by node 42 to the second terminal of grounded T-switch SW1 50, the equivalent circuit of which is represented in FIG. 2 by three constituent switches SW1a, SW1b, and SW1c. T-switch SW1 50 is used to reset the voltage across the integrating capacitor 20 to zero volts by shorting the nodes 11 and 42, thus shorting the integrating capacitor 20 through the closed switch SW4 30.

As is known to those skilled in the art, the T-switch SW1 50 operates such that when the T-switch is ON its two external terminals 50a and 50b are shorted through equivalent switches SW1a and SW1b that are closed and internal node 50i. Simultaneously the equivalent switch SW1c is open, so that internal node 50i is disconnected from the external terminal 50c. When the T-switch is OFF its two external terminals 50a and 50b are disconnected with equivalent switches SW1a and SW1b that are open. Simultaneously the equivalent switch SW1c is closed, so that internal node 50i is connected to the external terminal 50c. As discussed below, the use of the T-switch SW1 50 significantly reduces the error associated with the leakage of the charge (i.e., parasitic discharging) of integrating capacitor C_{INT} 20 through the open T-switch.

Node 42 is also connected to the first terminal of the switch SW3 80. The second terminal of switch SW3 80 is connected to node 81 which is at the same reference voltage potential V_{REF}, referred to here as the “virtual reference voltage,” as node 14.

Operational amplifier output 42 is coupled by switch SW2 to node 43, which is connected to the “fake” integrating capacitor C_{N} 70 and to one plate of “noise load” capacitor C_{NL} 75. The other plate of “noise load” capacitor C_{NL} 75 is connected to node 76 which is at the same reference voltage potential V_{REF}, referred here as the “virtual reference voltage,” as nodes 14 and 81.

Capacitor C_{NL} 75 reduces the kT/C noise generated at node 43 during the opening of switch SW2 60. Capacitor C_{N} 70 together with the connected-in-parallel capacitors C_{PHD} 16 and C_{INT} 20 forms a capacitive divider, which attenuates the kT/C noise generated at node 43 while transmitting it to node 11. The attenuation ratio is approximately determined by the ratio of the capacitance of C_{N} to the input capacitance of the integrator 5 at node 11 that can be approximated by C_{PHD}+C_{INT}. The capacitance values for the capacitors C_{N} 70 and C_{NL} 75 shown in FIG. 2 are exemplary and can have different values. For the sizable attenuation of the kT/C noise generated at node 43 the following conditions should be observed:

C_{N}<<C_{N};

C_{N}<<C_{PHD}+C_{INT}.

For example, the value of the capacitor C_{N} 70 can be in the range from 0.1 pF to 20 pF, and the value of the capacitor C_{NL} 75 can be from 10 pF to 200 pF.

Node 41 is also coupled to the first terminal of the load capacitor C_{L} 90, the second terminal of which is grounded at node 95. The capacitor C_{L} 90 is used for the attenuation of high-frequency noise at the output of the operational amplifier 6 and can be omitted. The capacitance value for the capacitor C_{L} 90 shown in FIG. 2 is for example only and can have a different value. For example, the value of the capacitor C_{L} 90 can be in the range from 0 pF to 200 pF.

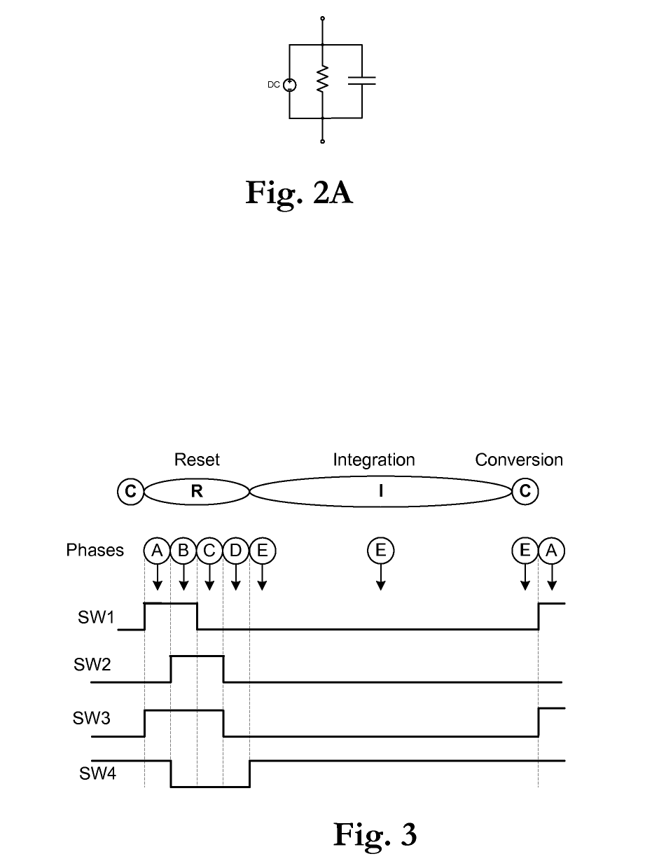

FIG. 3 shows a timing diagram of the signals which control the various switches operating in the embodiment of FIG. 2. Table 1, below, depicts the position of the switches during different phases of the integrator's operation. When a switch is in the ON state it is closed, when it is in the OFF state it is open.

TABLE 1

Switches Position

| Phases | SW1 | SW2 | SW3 | SW4 |
|---|---|---|---|---|
| A | ON | OFF | ON | ON |
| B | ON | ON | ON | OFF |
| C | OFF | ON | ON | OFF |
| D | OFF | OFF | OFF | OFF |
| E | OFF | OFF | OFF | ON |

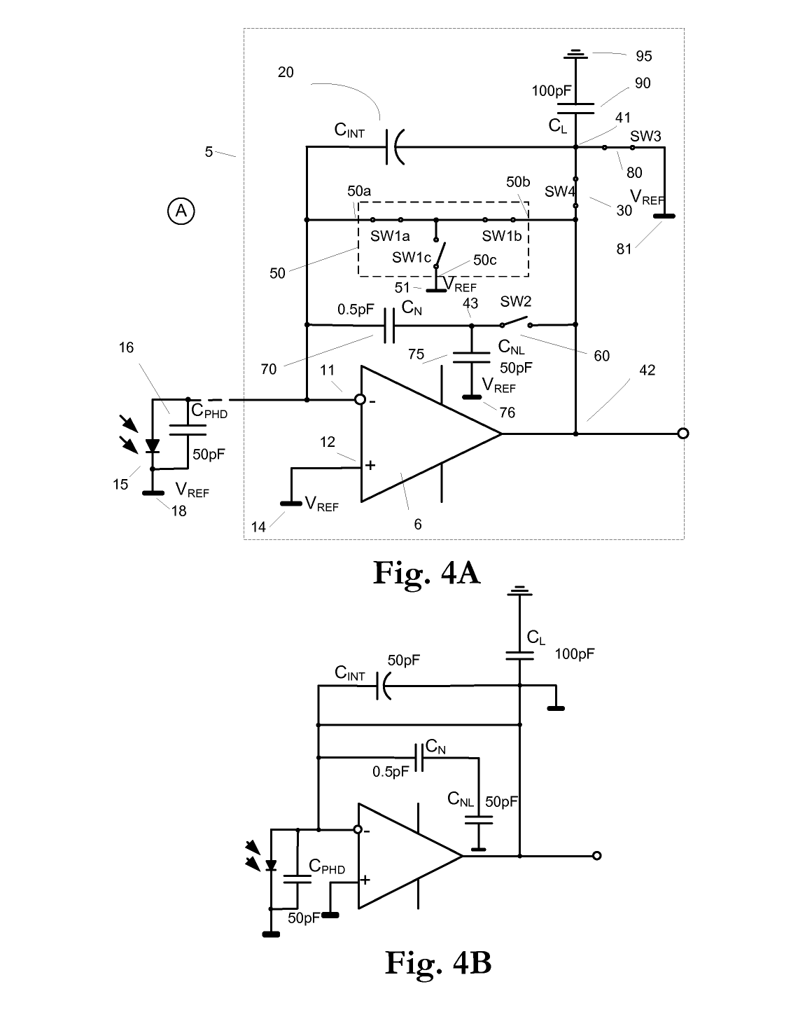

FIGS. 4A-8A are useful in describing the operation of the current integrating circuit 5 of FIG. 2 in its different phases of operation: Phase A—reset phase, Phase B—correlated double sampling phase, Phase C—fake integration phase, Phase D—guard phase, and Phase E—integration and hold-for-conversion phase. FIGS. 4B-8B show simplified circuits that are equivalent to the circuits illustrated in FIGS. 4A-8A.

At the end of the previous conversion cycle, the initial state of the integrator 5 is switched from Phase E to the reset Phase A, and the integrator 5 has the configuration shown in FIG. 4A. The states of the switches of the integrator 5 during Phase A can be determined from Table 1 and are shown in FIG. 4A. Switch SW1 50 is ON (switches 50a and 50b are closed, switch 50c is open), SW4 30 and SW3 80 are ON (closed), and switch SW2 60 is OFF (open).

At the end of the previous integration and conversion cycles (i.e., during Phase E—integration and hold-for-conversion phase) the capacitor C_{L} 90 was charged to the particular voltage V_{OUT-CONV} that directly relates to the charge accumulated on the integrator 5 during the previous integration cycle. The integrating capacitor C_{INT} 20 at the end of the previous Phase E was charged to the voltage equal to (V_{REF}−V_{OUT-CONV}). Connected-in-series capacitors C_{N} 70 and C_{NL} 75 are discharged to zero volts, as is parasitic capacitance C_{PHD} 16. Inverting input 11 of the operational amplifier 6 is at potential equal to V_{REF}.

The main goal of Phase A is to reset or discharge to zero volts the integrating capacitor C_{INT} 20 and charge the load capacitor C_{L} 90 to the reference voltage V_{REF}. This is done by short-circuiting the integrating capacitor C_{INT} 20 with T-switch SW1 50 (switches 50a and 50b are closed and switch 50c is open), and connecting the first terminal of the load capacitor C_{L} 90—node 41—to the reference voltage V_{REF} through closed switch SW3 80. The load capacitor C_{L} 90 is charged from the reference voltage source at node 81.

The output 42 of the operational amplifier 6 during the reset phase (Phase A) is connected to the amplifier's inverting input 11, putting the operational amplifier 6 in a unity gain feedback configuration. The output current of the operational amplifier 6 helps charge the load capacitor C_{L} 90 to the reference voltage V_{REF}, but the operational amplifier 6 is relatively slow and its influence at the loading process is insignificant.

The simplified equivalent circuit of the integrator 5 and photodiode 15 during the reset phase (Phase A) is shown in FIG. 4B. As shown by the equivalent circuit of FIG. 4B, during the reset phase (Phase A) the integrating capacitor C_{INT} is short-circuited and is reset or discharged to zero volts through the closed switch SW1 50, and the load capacitor C_{L} 90 is charged from the reference voltage source V_{REF} through closed switch SW3 80.

Because the load capacitor C_{L} 90 has a relatively large capacitance value, sometimes special precautions should be taken. If several integrators 5 are simultaneously connected to the same power source providing the reference voltage V_{REF} and there is a need to limit the current load for this power source, the switch SW3 80 can be replaced by a more complicated combination (not shown) including the switch in parallel with the non-inverting unity gain buffer, the output of which through the additional switch is connected to the node 41.

The non-inverting unity gain buffer allows coarse but rapid partial precharging of C_{L} 90 to nearly reference voltage V_{REF} without overloading a precision voltage reference source. The input of the non-inverting unity gain buffer should be connected to the reference voltage source, and the output of the buffer to node 41.

Phase A can be divided into two sub-phases. During the first sub-phase, switch SW3 80 is still open, the additional switch (not shown) is closed, and the output of the non-inverting unity gain buffer is connected to the node 41. During this sub-phase, the capacitor C_{L} 90 is precharged to nearly reference voltage V_{REF} from the output of the non-inverting unity gain buffer. During the second sub-phase the additional switch is open, disconnecting the output of non-inverting unity gain buffer from node 41, and the switch SW3 80 is closed. This allows the remaining “fine” charging of C_{L} 90 precisely to reference voltage V_{REF} without disturbing the precision reference voltage source, because very little additional charge is needed to finish charging C_{L} 90. In this case, during both sub-phases of Phase A the integrating capacitor C_{INT} 20 is short-circuited and is reset or discharging to zero volts through the closed switch SW1 50.

At the end of Phase A, the integrating capacitor C_{INT} 20 is discharged to zero volts, the load capacitor C_{L} 90 is charged to the reference voltage V_{REF}, the potential of the inverting input 11 of the operational amplifier 6 is at reference voltage V_{REF}, and the parasitic capacitance C_{PHD} is discharged. When this process is finished, the switch SW4 30 is open, switch SW2 60 is closed, and the integrator 5 is switched to Phase B, the correlated double sampling phase.

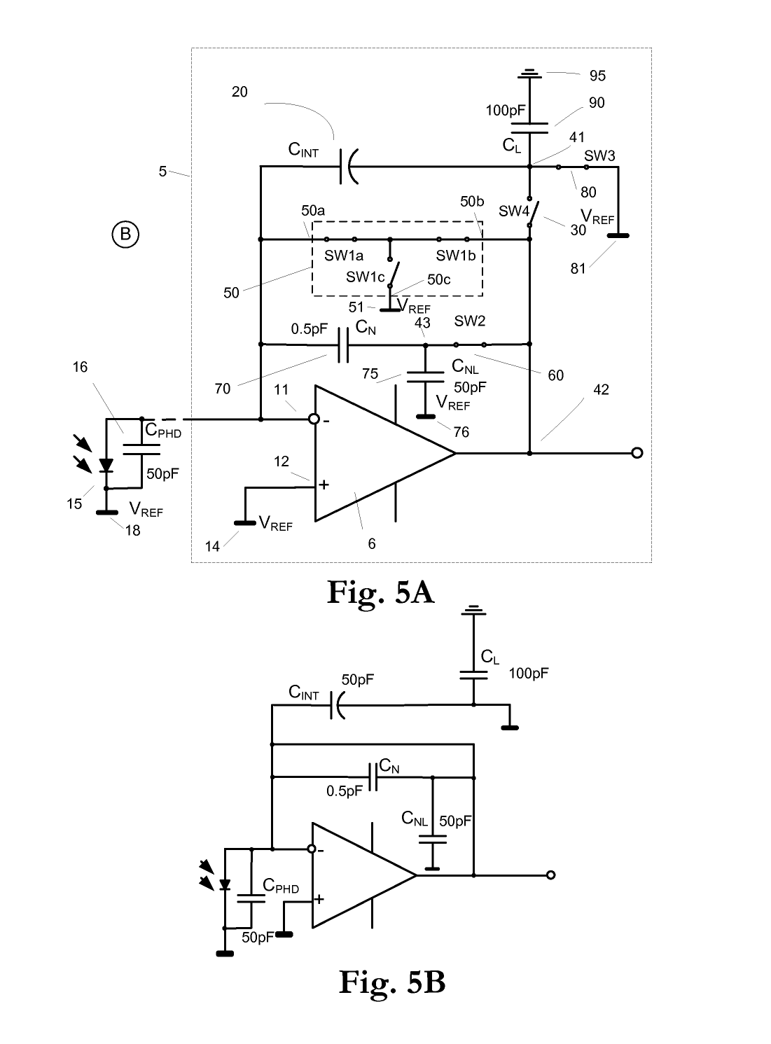

In Phase B, the integrator 5 has the configuration shown in FIG. 5A. The states of the switches of the integrator 5 during Phase B can be determined from Table 1 and are as shown in FIG. 5A. Switch SW1 50 is ON (switches 50a and 50b are closed, and switch 50c is open), SW2 60 and SW3 80 are ON (closed), and switch SW4 30 is OFF (open). The output of the operational amplifier 6 during Phase B is still connected to its inverting input 11, putting the operational amplifier 6 in a unity gain feedback configuration. The simplified equivalent circuit of the integrator 5 and photodiode 15 during Phase B is shown in FIG. 5B.

The main goal of Phase B is to sample the value of the DC offset of operational amplifier 6 and significant low frequency 1/f noise in the integrator at the beginning of Phase B, and to reset the noise capacitor C_{N} 70. The sampled value of the DC offset and low frequency noise will be used in the process of correction using correlated double sampling (CDS) during the integration cycle.

When the switch SW4 30 is opened, kT/C noise is generated at node 42 and at node 11, which is connected to node 42. The value of kT/C noise at node 11 is determined by the sum of the parallel-connected capacitors C_{INT} 20 and C_{PHD} 16 and is relatively high, although small in comparison with other noise present in the circuit, such as 1/f noise, operational amplifier thermal noise, etc.

When the switch SW4 30 is opened, the internal errors on the output 42 of the operational amplifier 6 represent the sum of the DC offset voltage, low frequency 1/f noise, the thermal noise of operational amplifier 6, as well as kT/C noise and charge injection error generated during the opening of SW4 30. These errors are sampled at the output 42 of the amplifier 6 and node 11, which is connected to node 42. Because the operational amplifier 6 is in a unity gain feedback configuration, all components of the noise except DC offset and low frequency 1/f noise will be eliminated by operational amplifier 6.

The voltage representing the sum of the sampled values of the DC offset and low frequency 1/f noise is stored at node 11 on the parallel-connected capacitors C_{INT} 20 and C_{PHD} 16. Both capacitors, C_{INT} 20 and C_{PHD} 16, will be charged to the same exact potential relative to the reference voltage V_{REF}.

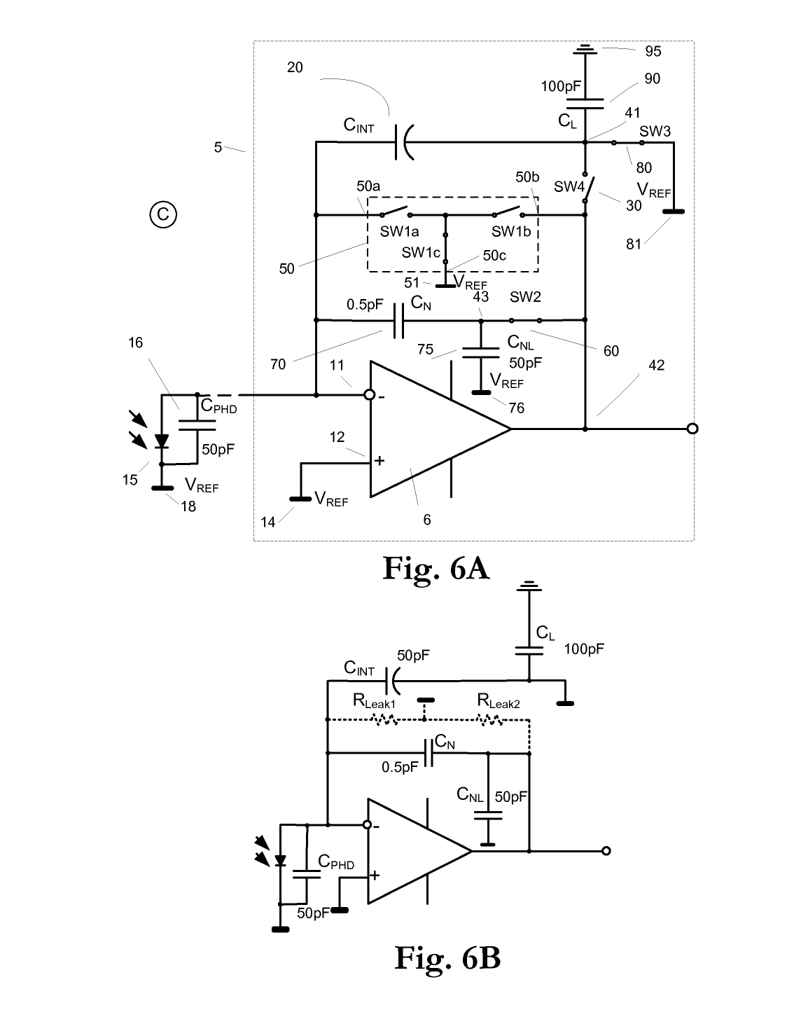

Next the T-switch SW1 50 will be switched OFF, bringing the integrator 5 into Phase C, the fake integration phase. In Phase C, the integrator 5 has the configuration as shown in FIG. 6A. The states of the switches of the integrator 5 during Phase C can be determined from Table 1 and are as shown in FIG. 6A.

With continued reference to FIG. 6A, switch SW1 50 is OFF (i.e., switches SW1a 50a and SW1b 50b are opened, and switch SW1c 50c is closed), switches SW2 60 and SW3 80 are ON (closed), and switch SW4 30 is OFF (open). The output of the operational amplifier 6 during Phase C is connected to its inverting input 11 through the noise capacitor C_{N} 70, putting the operational amplifier 6 into an integrator configuration with the capacitor C_{N} 70 serving as the integrating capacitor. The noise load capacitor C_{NL} 75 is connected as capacitive load to the output of the integrator.

The capacitors C_{INT} 20 and C_{PHD} 16 are connected in parallel and coupled to the inverting input 11 of the integrator. The voltage on the parallel-connected capacitors C_{INT} 20 and C_{PHD} 16 at node 11 is equal to the sampled sum of the DC offset voltage, 1/f noise, and high-frequency noises at the output of operational amplifier 6, plus the kT/C noise and charge injection noise, all sampled at the beginning of Phase C.

The main goal of Phase C is the elimination of kT/C noise, high-frequency noises at the output of operational amplifier 6, and charge injection noises, which were sampled during the opening of T-switch SW1 50 at the beginning of Phase C, while leaving the parallel-connected capacitors C_{INT} 20 and C_{PHD} 16 still charged to the value of main low frequency noises of the operational amplifier 6: i.e., 1/f noise and offset as they were sampled at the beginning of Phase B.

A simplified equivalent circuit of the integrator 5 and photodiode 15 during Phase C is shown in FIG. 6B. Opening the equivalent switches SW1a and SW1b and closing the equivalent switch SW1c created the equivalent circuitry containing two very high resistance resistors (i.e., hundreds MOhm values) connected to the reference voltage V_{REF} at the node 51. One of these very high resistance resistors (R_{Leak1} in FIG. 6B) connected to node 11 will introduce tiny additional input leakage, reducing the input impedance of the operational amplifier 6. Another very high resistance resistor (R_{Leak2} in FIG. 6B) connected to node 42 will introduce tiny additional output load at the output of the operational amplifier 6.

During Phase C the operational amplifier 6 is in the integrator configuration, where the capacitor C_{N} 70 plays the role of an integrating capacitor. At the beginning of Phase C the voltage difference between the inverting input 11 and non-inverting input 12 of the operational amplifier 6 is equal to the sampled value of the sum of DC offset, 1/f noise, kT/C noise, high-frequency noises at the output of operational amplifier 6, and charge injection error, At the end of Phase C the voltage difference between the inverting input 11 and non-inverting input 12 of the operational amplifier 6 will be equal to the sampled value of the DC offset, 1/f noise.

This essentially eliminates the additional error voltage related to the sampled kT/C noise, high-frequency noises at the output of operational amplifier 6, and charge injection error from the parallel-connected capacitors C_{INT} 20 and C_{PHD} 16 at node 11.

At the end of the fake integration phase (Phase C) the error voltage at node 11 on the parallel-connected capacitors C_{INT} 20 and C_{PHD} 16 is related only to the sum of the DC offset voltage and 1/f noise of operational amplifier 6. The capacitor C_{N} 70 will be charged to compensate for the sampled kT/C, high-frequency noises at the output of operational amplifier 6, and charge injection errors.

Next, the switch SW2 60 and after a small delay the switch SW3 80 will be switched OFF, bringing the circuitry into Phase D, the guard phase. Phase D can have a very short duration, and can be replaced in some embodiments by short delays between switching OFF switch SW2 60, switching OFF SW3 80, and switching ON switch SW4 30, which will later bring the circuit into Phase E.

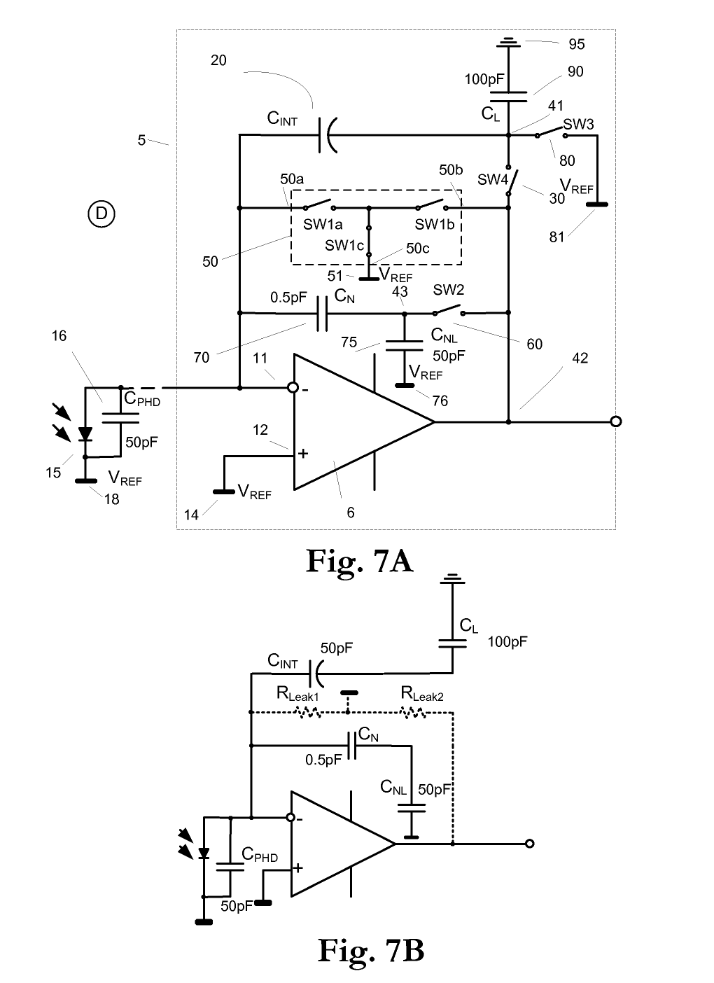

At Phase D, the integrator 5 has the configuration shown in FIG. 7A. The states of the switches of the integrator 5 during Phase D may be determined from Table 1 and are as shown in FIG. 7A. The simplified equivalent circuit of the integrator 5 and photodiode 15 during Phase D is shown in FIG. 7B.

As depicted in FIG. 7A, switch SW1 50 is OFF (switches SW1a and SW1b are opened, switch SW1c is closed), and switches SW2 60, SW3 80, and SW4 30 are OFF (i.e., open). The output of the operational amplifier 6 during Phase D is disconnected, bringing operational amplifier 6 into an open feedback configuration.

When two switches SW2 60 and SW3 80 are sequentially opened, kT/C noises and charge injection errors will be generated at nodes 41 and 43 and sampled on the capacitors connected to these nodes. Due to the arrangement of the circuitry of the integrator 5, the values of the introduced sampled noises will be significantly lower than in prior art arrangements.

The value of the kT/C noise generated by opening SW2 60 will be determined by the parallel connection of the relatively large capacitor C_{NL} 75, connected-in-series very small capacitor C_{N} 70, and relatively large capacitor C_{PHD} 16 in parallel with C_{INT} 20. As a result, the kT/C noise will be small because of the large value of C_{NL} 75.

The noise voltage introduced at node 43 by opening SW2 60 during switching to Phase D and equal to the sum of sampled kT/C, high-frequency noises at the output of operational amplifier 6, and charge injection errors will be to a great degree attenuated at node 11 by the capacitance divider: C_{N}—(parallel-connected C_{PHD} 16 and C_{INT} 20). The majority of the error voltage introduced during switching to Phase D, which will influence the results of the integration during the following Phase E (integration and hold-for-conversion), will be stored on small capacitor C_{N} 70, and an insignificant part of the error voltage will be stored on the capacitors C_{INT} 20 and C_{PHD} 16.

This negligible error voltage practically will not disturb the charge on capacitors C_{INT} 20 and C_{PHD} 16, which will be still charged to the value of main low frequency noises of the operational amplifier 6: i.e., 1/f noise, and offset as they were sampled at the beginning of Phase B.

The error voltage introduced by kT/C noise at node 41 by opening SW3 80 during switching to Phase D is determined by the parallel connection of the large load capacitor C_{L} 90 and connected-in-series C_{INT} 20 and C_{PHD} 16. The influence of the connected-in-series C_{N} 70 and C_{NL} 75 is negligible because of the very small value of C_{N} 70. The feedback in the operational amplifier 6 is disconnected. The error charges introduced by kT/C at node 41 during switching to Phase D and stored on capacitors C_{INT} 20 and C_{PHD} 16 are the same and will be completely compensated on the next phase.

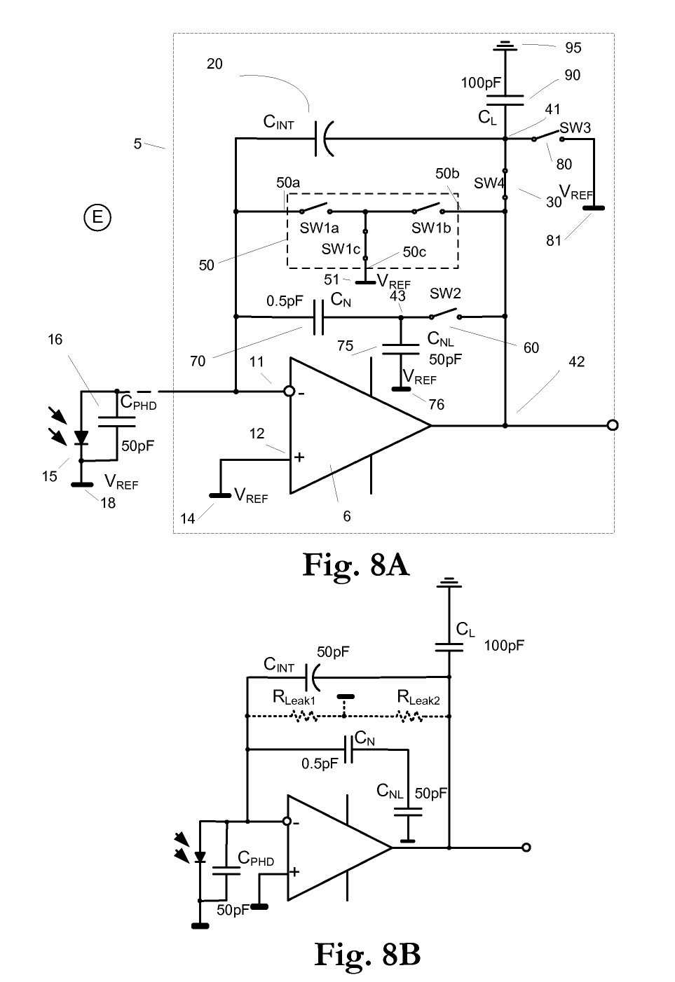

With switch SW4 30 ON, the circuitry is brought to an integrator configuration with the capacitor C_{INT} 20 serving as the integrating capacitor, and Phase E begins. Phase E is the integration and hold-for-conversion phase. At Phase E, the integrator 5 has the configuration shown in FIG. 8A. The states of the switches of the integrator 5 during Phase E may be determined from Table 1 and are as shown in FIG. 8A. The simplified equivalent circuit of the integrator 5 and photodiode 15 during Phase E is shown in FIG. 8B.

As shown in FIG. 8A, switch SW1 50 is OFF (switches SW1a and SW1b are open, switch SW1c is closed), switches SW2 60 and SW3 80 are OFF (open), and switch SW4 30 is ON. The output of the operational amplifier 6 during Phase E is connected to the node 41 bringing it into an integrator configuration with the capacitor C_{INT} 20 serving as the integrating capacitor.

Because the sample operation at the beginning of Phase B resulted in nearly equal but opposite polarity DC offset and low frequency error voltages stored on integrating capacitor C_{INT} 20 and parasitic capacitor C_{PHD} 16, the DC and low frequency errors voltage, which is equal to the sum of the DC offset voltage, and 1/f noise of operational amplifier 6, is mutually cancelled as a result of the correlated double sampling operation.

Referring to the equivalent circuit in FIG. 8B, the capacitors C_{INT} 20 and C_{PHD} 16 are almost completely discharged, and the residual voltage on these capacitors is the error voltage associated with operational amplifier offset and a low frequency 1/f noise to be compensated by correlated double sampling.

Integrating circuit 5 is now ready to integrate the input photocurrent from the photodiode 15. In response to incoming light the photodiode 15 generates photocurrent. Operational amplifier 6 decreases its output voltage at node 42 from the initial V_{REF} voltage as necessary to cause integrating capacitor C_{INT} 20 to balance the input photocurrent to maintain the inverting input at node 11 at the virtual reference voltage. The charge on and voltage across the integrating capacitor C_{INT} 20 are increasing. After the integration cycle is complete, the output voltage of the integrator 5 at node 42 is suitable for conversion into a digital value using, e.g., an analog-to-digital converter.

The T-switch SW1 is off, and its equivalent schematics shows two high voltage resistors (R_{Leak1} and R_{Leak2} in FIG. 8B) connected between the inverting input of the operational amplifier and the virtual reference, and the output of the operational amplifier and the virtual reference, respectively. This arrangement effectively prevents the discharge of the integrating capacitor C_{INT} during integration. The current leakage through R_{Leak2} will be compensated by operational amplifier. The leakage through R_{Leak1} at the inverting input of the operational amplifier will be extremely small. The operational amplifier 6 connected in the integrator configuration is bringing the potential of its inverting input equal (with the accuracy up to the DC offset and 1/f operational amplifier noise) to the virtual reference voltage. Hence, the equivalent resistor R_{Leak1} is connected between the nodes that have about the same potential, and leakage current through it is effectively equal to zero.

As is evident from the above description, embodiments of the current invention use correlated double sampling to compensate for DC offset and low frequency noises of the operational amplifier, and fake integration and the use of a capacitor divider to eliminate or significantly reduce kT/C noises and charge injections which emerged during the opening of internal switches and were sampled by different internal capacitors. Such elimination or significant reduction takes place when any switch in the circuitry is opened and kT/C noise is sampled on a capacitor. In the proposed arrangement, every kT/C noise error is eliminated or significantly reduced.

One advantage of the proposed arrangement is that kT/C noise is suppressed for both capacitors—the integrating capacitor C_{INT} and the parasitic photodiode capacitor C_{PHD}. Still another advantage of the proposed arrangement is that fake integration eliminates not just the thermal noise of the switching circuitry (kT/C and charge injection) but also the sampled high-frequency noise of the operational amplifier. In addition, the use of a T-switch to short the integrating capacitor during the reset phase essentially eliminates the charge leakage across the integrating capacitor and prevents parasitic discharge of the integrating capacitor during the integration and hold-for-conversion phase.

The above-described integrator can be operated from a single power supply, and thus can be used as a front-end integrator with a single-supply analog-to-digital converter. The described structure and technique for including the CDS capacitor in the integrator feedback loop after the integration results in a very accurate output voltage for sampling by, for example, the input of an analog-to-digital converter. The bandwidth control capability of the operational amplifier results in both good noise performance and fast settling times during sampling of the integrator contact voltage by, e.g., the input of an analog-to-digital converter, with the result of fast overall conversion of the input photocurrent to a digital value. The programmable integrating capacitor allows “on-the-fly” gain modification, which may be useful in some applications.

The principles of the invention are equally applicable to an integrator in which the input current flows out of the inverting input of the operational amplifier so that its output voltage increases during integration. Also, it is not necessary that the CDS capacitor be reset.

It will therefore be seen that the foregoing represents a highly advantageous approach to current-to-voltage conversion. The terms and expressions employed herein are used as terms of description and not of limitation and there is no intention, in the use of such terms and expressions, of excluding any equivalents of the features shown and described or portions thereof, and it is recognized that various modifications are possible within the scope of the invention claimed.

What is claimed is:

1. A current-to-voltage integrator comprising:
an operational amplifier having an inverting input receiving an input signal, an output, and a non-inverting input coupled to a reference voltage;
first switching circuitry having a first terminal coupled to the output and a second terminal;
a first integrating capacitor having a first terminal coupled to the inverting input and a second terminal coupled to the second terminal of the first switch;
second switching circuitry having a first terminal coupled to the output and a second terminal;
a second integrating capacitor having a first terminal coupled to the inverting input and a second terminal coupled to the second terminal of the second switch;
third switching circuitry having a first terminal coupled to the inverting input and a second terminal coupled to the output; and
fourth switching circuitry having a first terminal coupled to the second terminal of the first integrating capacitor and a second terminal coupled to the reference voltage,
wherein the switching circuitries are configured for operation so as to integrate the input signal on the first integrating capacitor and to integrate kT/C noise on the second integrating capacitor.

2. The integrator of claim 1 wherein the first integrating capacitor is a programmable capacitor array.

3. The integrator of claim 1 wherein the third switching circuitry is a T-switch having a third terminal connected to the reference voltage.

4. The integrator of claim 1 having a photodiode with an anode coupled to the inverting input and cathode coupled to the reference voltage, wherein the input signal is the current generated by the photodiode.

5. The integrator of claim 1 further comprising a noise-suppressing capacitor, the noise-suppressing capacitor having a first terminal coupled to the second terminal of the second integrating capacitor and a second terminal coupled to a reference voltage.

6. The integrator of claim 5 wherein the noise-suppressing capacitor is larger than the second integrating capacitor.

7. The integrator of claim 1 further comprising a signal generator coupled to at least one switching circuitry and generating signals controlling the operation of said at least one switching circuitry.

8. The integrator of claim 1 further comprising a load capacitor coupled to the second terminal of the first integrating capacitor.

9. The integrator of claim 1 having the output of the operational amplifier coupled to an analog-to-digital converter.

10. A current-to-voltage integrator comprising:
an operational amplifier having an inverting input receiving an input signal, an output, and a non-inverting input coupled to a reference voltage;
first switching circuitry having a first terminal coupled to the output and a second terminal;
a first integrating capacitor having a first terminal coupled to the inverting input and a second terminal coupled to the second terminal of the first switch;
second switching circuitry having a first terminal coupled to the output and a second terminal;
a second integrating capacitor having a first terminal coupled to the inverting input and a second terminal coupled to the second terminal of the second switch;
third switching circuitry having a first terminal coupled to the inverting input and a second terminal coupled to the output;
fourth switching circuitry having a first terminal coupled to the second terminal of the first integrating capacitor and a second terminal coupled to the reference voltage; and
a noise-suppressing capacitor, the noise-suppressing capacitor having a first terminal coupled to the second terminal of the second integrating capacitor and a second terminal coupled to the reference voltage,
wherein the noise-suppressing capacitor is larger than the second integrating capacitor.

11. The integrator of claim 10 wherein the first integrating capacitor is a programmable capacitor array.

12. The integrator of claim 10 wherein the third switching circuitry is a T-switch having a third terminal connected to the reference voltage.

13. The integrator of claim 10 having a photodiode with an anode coupled to the inverting input and a cathode coupled to the reference voltage, wherein the input signal is the current generated by the photodiode.

14. The integrator of claim 10 further comprising a signal generator coupled to at least one switching circuitry and generating signals controlling the operation of said at least one switching circuitry.

15. The integrator of claim 10 further comprising a load capacitor coupled to the second terminal of the first integrating capacitor.

16. The integrator of claim 10 having the output of the operational amplifier coupled to an analog-to-digital converter.
